(19) United States
(12) Patent Application Publication
(10) Pub. No.: US 2008/0152310 A1
(43) Pub. Date: Jun. 26, 2008

(54) AUDIO/VIDEO STREAM COMPRESSOR AND AUDIO/VIDEO RECORDER

(76) Inventor: Eiji Miyagoshi, Osaka (JP)

Correspondence Address: MCDERMOTT WILL & EMERY LLP, 600 13TH STREET, NW, WASHINGTON, DC, 20005-3096, US

(21) Appl. No.: 11/942,479

(22) Filed: Nov. 19, 2007

(30) Foreign Application Priority Data
Dec. 20, 2006 (JP) 2006-342202

(51) Int. Cl. H04N 7/26

(52) U.S. Cl. 386/96; 375/240.26; 386/E05.007; 375/E07.026

(57) ABSTRACT

A video compression processing section capable of compressing a video stream in multiple different compression modes is provided. An audio compression processing section capable of compressing an audio stream in multiple different compression modes is also provided. And a system control section determines a compression mode in the video compression processing section and a compression mode in the audio compression processing section.

### CROSS REFERENCE TO RELATED APPLICATION

The disclosure of Japanese Patent Application No. 2006-342202 filed on Dec. 20, 2006 including specification, drawings and claims is incorporated herein by reference in its entirety.

### BACKGROUND OF THE INVENTION

1. Field of the Invention

The present invention relates to an audio/video stream compressor which compresses a video stream and an audio stream, and an audio/video recorder which compresses a video stream and an audio stream and records the compressed streams on a recording medium.

2. Description of the Related Art

Examples of video recorders, which digitally compress video contents, such as analog television broadcasts, and then record the compressed contents, include HDD (Hard Disk Drive) recorders and DVD (Digital Versatile Disc) recorders. Some of these video recorders have been developed to have an automatic recording reservation feature (which is called “Okonomi (according to user's preference)” recording feature or “Omakase (leave it to us)” recording feature), in which if a user receives program listing data that contains information indicating TV program listing, and specifies keywords, etc., recording reservations for broadcast programs whose information contains those specified keywords, etc. are made automatically.

Also, in recent years, as BS (Broadcasting Satellite) digital broadcasting, 110CS (Communication Satellite) broadcasting, and digital terrestrial broadcasting have become widely available, DVD recorders having a mode (commonly called DR mode), in which a digitized compressed stream is directly recorded on the HDD, have become popular. Major differences between digital broadcasting and analog television broadcasting are that, in digital broadcasting, compressed digital broadcasts are sent from broadcasters, and up to 5.1 channels are available for audio, allowing higher audio quality as compared with conventional analog television. And for images, HD (high definition) video technology is adopted in digital broadcasting, which enables the images to have a significantly higher resolution than that of conventional analog television.

For BD (Blu-ray Disc) players and recorders, which have been commercialized recently, there are six types of audio codecs (i.e., LPCM, Dolby Digital, Dolby Digital Plus, Dolby Lossless, DTS digital surround, and DTS-HD), and, in addition, up to eight channels are available. That is, the number of audio codecs has been increased remarkably as compared with conventional DVD recorders having two types of audio codecs, which are LPCM and Dolby Digital.

In such a situation, television broadcasts and contents are thus provided in a variety of ways, while high-definition video has caused recording rate to become increasingly higher. Therefore, when content recorded on a HDD, for example, is recorded on another recording medium, the recording-destination recording medium may suffer capacity shortage. For instance, depending upon the recording rate, a single-layer BD (Blue-ray Disc) provides only up to about three hours of recording, and a double-layer BD offers only up to about six hours of recording. Furthermore, at this point in time, the price of Blu-ray Discs is about 100 times higher than that of DVD-Rs, and thus there is a demand for a video recorder capable of compressing and recording content in a more efficient manner.

In view of this, a video recorder has been disclosed (for example, in Japanese Laid-Open Publication No. 2006-115224 (hereinafter referred to as “Patent Document 1”)), in which, based on data indicating playback conditions for content, for example a recoding mode is determined, in which a program whose recording reservation was made under the same conditions as registration conditions for the content will be recorded. In this recorder, since one of the recoding modes called XP, SP, LP, etc. (in each recording mode, a compression mode for a video stream and a compression mode for an audio stream are predetermined) is selected automatically, the limited capacity of the storing medium can be used efficiently.

However, in the video recorder described in Patent Document 1, the compression mode for the video stream and the compression mode for the audio stream are determined in a uniform manner according to the selected recording mode. Depending on the selected mode, even in the case of content which places importance on audio quality, the audio quality might deteriorate to the extent that the content loses its charm, or in the case of content in which video quality is important, the video quality may decline to the extent that the content loses its attractiveness.

### SUMMARY OF THE INVENTION

The present invention was made in view of the above problem, and it is therefore an object of the invention to compress a video stream and an audio stream with necessary image quality and audio quality maintained.

In order to achieve the object, according to the invention, a compression mode for a video stream and a compression mode for an audio stream are set individually.

For example, an inventive audio/video stream compressor for compressing a video stream and an audio stream contained in content includes: a video compression processing section capable of compressing the video stream in multiple different compression modes; an audio compression processing section capable of compressing the audio stream in multiple different compression modes; and a system control section for determining a compression mode in the video compression processing section and a compression mode in the audio compression processing section, wherein the video compression processing section and the audio compression processing section compress the video stream and the audio stream, respectively, in the respective compression modes determined by the system control section.

### BRIEF DESCRIPTION OF THE DRAWINGS

FIG. 1 is a block diagram illustrating the configuration of an audio/video recorder 100 according to a first embodiment.

FIG. 2 is a block diagram illustrating an example of the configuration of a video compression processing section 134.

FIG. 3 is a block diagram illustrating an example of the configuration of an audio compression processing section 135.

### DETAILED DESCRIPTION OF THE INVENTION

Hereinafter, embodiments of the present invention will be described with reference to the accompanying drawings. In the following embodiments and the modified examples thereof, components having the same functions as those already described are identified by the same reference numerals, and the description thereof will be omitted.

### First Embodiment of the Invention

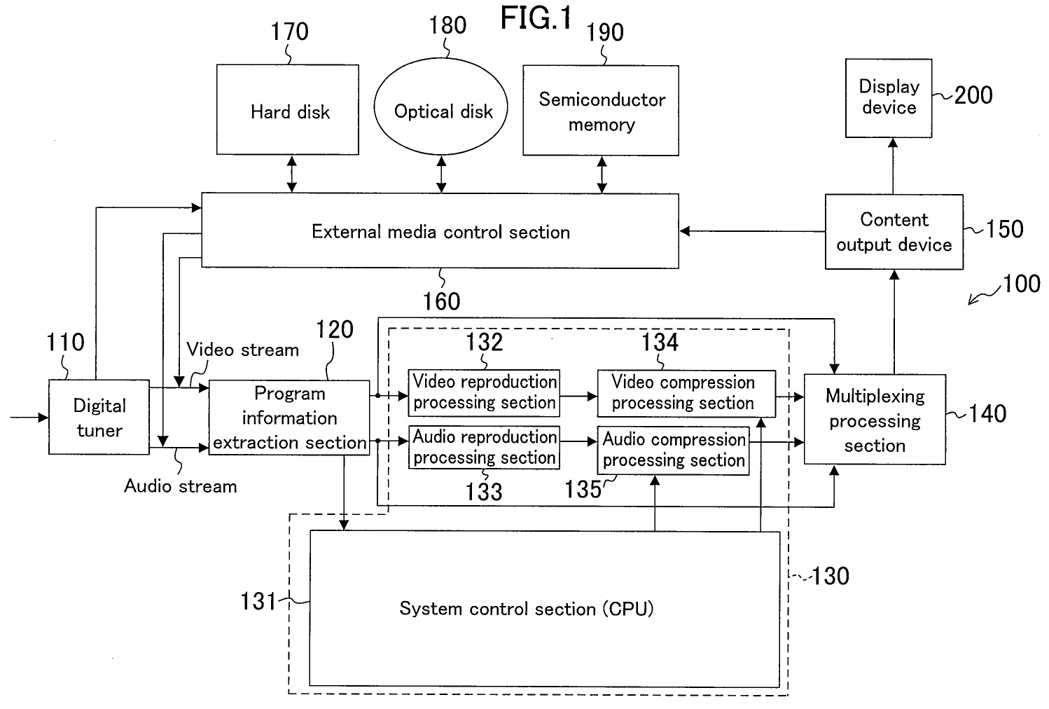

FIG. 1 is a block diagram illustrating the configuration of an audio/video recorder 100 according to a first embodiment of the invention. The audio/video recorder 100 has the function of receiving digital broadcast content (containing a video stream and an audio stream), and the following three functions.

First, the audio/video recorder 100 compresses received content or content recorded on a hard disk 170, an optical disk 180, or a semiconductor memory 190 to a smaller size than the original size and then records the compressed content on the hard disk 170, the optical disk 180, or the semiconductor memory 190. The second function is to record received content itself on the hard disk 170, the optical disk 180, or the semiconductor memory 190. Thirdly, the audio/video recorder 100 outputs received content or content recorded on the hard disk 170, the optical disk 180, or the semiconductor memory 190 to a display device 200.

Examples of digital broadcasts that the audio/video recorder 100 receives include digital terrestrial broadcasts, BS digital broadcasts, and 110CS digital broadcasts, for example. Generally, when these digital broadcasts are received, electronic program guides (hereinafter abbreviated as “EPGs”) can be received together with the contents. In the case of a terrestrial digital broadcast, a data broadcast which contains information on the content is often provided.

(Configuration of the Audio/Video Recorder 100)

As shown in FIG. 1, the audio/video recorder 100 includes a tuner 110, a program information extraction section 120, an audio/video stream compressor 130, a multiplexing processing section 140, a content output device 150, and an external media control section 160.

The tuner 110 is a digital tuner which receives digital broadcast content. The tuner 110 separates a video stream and an audio stream (each of which is a compressed stream) contained in the received content from each other and outputs the separate streams. Furthermore, the tuner 110 outputs an EPG, and, in the case of receiving a digital terrestrial broadcast, outputs a data broadcast.

The program information extraction section 120 extracts program information contained in the EPG or in data in the data broadcast output from the tuner 110 and outputs the extracted program information to the audio/video stream compressor 130. In this embodiment, the program information that the program information extraction section 120 extracts is information about the genre of the content (program). The “genre” indicates the kind of the content, such as music, sport, movie, etc.

Moreover, when content recorded on one of the hard disk 170, the optical disk 180, and the semiconductor memory 190 is recorded on another, the program information extraction section 120 also extracts information indicating the kind (the title, genre, etc.) of the recorded content from the recorded content and outputs the extracted information to the audio/video stream compressor 130. The program information extraction section 120 also outputs to the audio/video stream compressor 130 a video stream and an audio stream in the state in which these streams were received.

The audio/video stream compressor 130 is configured so as to be capable of compressing a video stream and an audio stream in multiple different compression modes; the audio/video stream compressor 130 determines an individual compression mode for each of the received video stream and audio stream, and then outputs the video stream and the audio stream each compressed in the determined compression mode.

The “compression mode” herein includes both a compression algorithm and a compression ratio. Examples of the compression algorithm include MPEG4-AVC (Moving Pictures Experts Group Advanced Video Coding), which is a compression standard in terrestrial digital one segment broadcasting, MPEG2 (Moving Pictures Experts Group), which is a standard in digital terrestrial broadcasting, and VC1, which is a compression standard for BD recorders. The “compression ratio” in the case of a video stream includes image resolution, frame rate, etc., and, in the case of an audio stream, includes sampling rate and the number of output channels.

In this embodiment, according to the kind of the content, the audio/video stream compressor 130 determines an individual compression mode for the video stream and an individual compression mode for the audio stream. In the determination process, if the audio/video stream compressor 130 determines that the compression mode of a stream at the time of input does not have to be changed, the audio/video stream compressor 130 performs control so that the stream is output in the same state in which the stream was input. Herein, compression of a stream in a compression mode different from the compression mode of the stream at the time of input is called recompression.

The audio/video stream compressor 130 specifically includes a system control section 131, a video reproduction processing section 132, an audio reproduction processing section 133, a video compression processing section 134, and an audio compression processing section 135.

The system control section 131 analyzes the kind of the content based on the information extracted by the program information extraction section 120 and determines an individual compression mode for each of the video stream and the audio stream to be output, by selecting from compression modes in which the audio/video stream compressor 130 can perform compression.

To be specific, when the system control section 131 determines, according to the information about the genre of the content, that the content places importance on audio, the system control section 131 performs control so that the input audio stream as it is output to the multiplexing processing section 140, while determining a compression mode in the video compression processing section 134 so that the video stream is compressed to a smaller size as compared with the state in which the video stream was input. Examples of the genre in which audio is important include a case in which content is a music concert program, for example.

When the system control section 131 determines that the genre of the content places importance on video, the system control section 131 performs control so that the input video stream as it is output to the multiplexing processing section 140, while determining a compression mode in the audio compression processing section 135 so that the audio stream is compressed to a smaller size as compared with the state in which the audio stream was input. Examples of the genre in which video is important include nature programs which provide images of nature, for example.

The system control section 131 is often configured to incorporate a CPU (Central Processing Unit) and a DRAM (Dynamic RAM). When configured in such a way, the system control section 131 reads, upon startup, a program stored in an externally provided flash ROM (Flash Read Only Memory) or the like and performs the control described above.

The video reproduction processing section 132 decodes the input video stream into a baseband signal (hereinafter referred to as a “video baseband signal”) and outputs the video baseband signal to the video compression processing section 134.

The audio reproduction processing section 133 decodes the input audio stream into a baseband signal (hereinafter referred to as an “audio baseband signal”) and outputs the audio baseband signal to the audio compression processing section 135.

The video compression processing section 134 is capable of compressing the input video baseband signal in multiple different compression modes (in multiple different image resolutions in this embodiment) and outputs to the multiplexing processing section 140 a video stream obtained by compressing the input video baseband signal in accordance with the compression mode determined by the system control section 131.

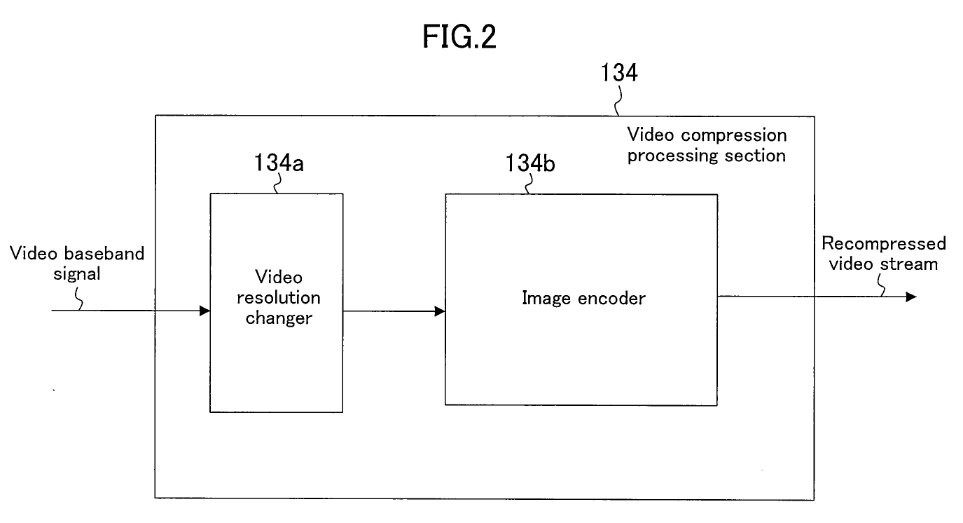

FIG. 2 is a block diagram illustrating an example of the configuration of the video compression processing section 134. The video compression processing section 134 changes the image resolution of the video baseband signal, compresses the signal obtained by the resolution change, and outputs the compressed signal. Specifically, the video compression processing section 134 includes a video resolution changer 134a and an image encoder 134b.

The video resolution changer 134a is capable of changing the image resolution of the input video baseband signal to multiple different image resolutions, and changes the image resolution of the input video baseband signal to an image resolution corresponding to the compression mode determined by the system control section 131.

The image encoder 134b outputs a video stream obtained by recompressing with a given compression algorithm the video baseband signal output from the video resolution changer 134a. The compression algorithm in the image encoder 134b is not particularly limited. For example, the above-described MPEG4-AVC, MPEG 2, VC1, which is a compression standard for BD recorders, or the like, may be used.

The audio compression processing section 135 is capable of compressing the input audio baseband signal in multiple different compression modes (different numbers of channels in this embodiment) and outputs to the multiplexing processing section 140 an audio stream obtained by compressing the input audio baseband signal according to the compression mode determined by the system control section 131.

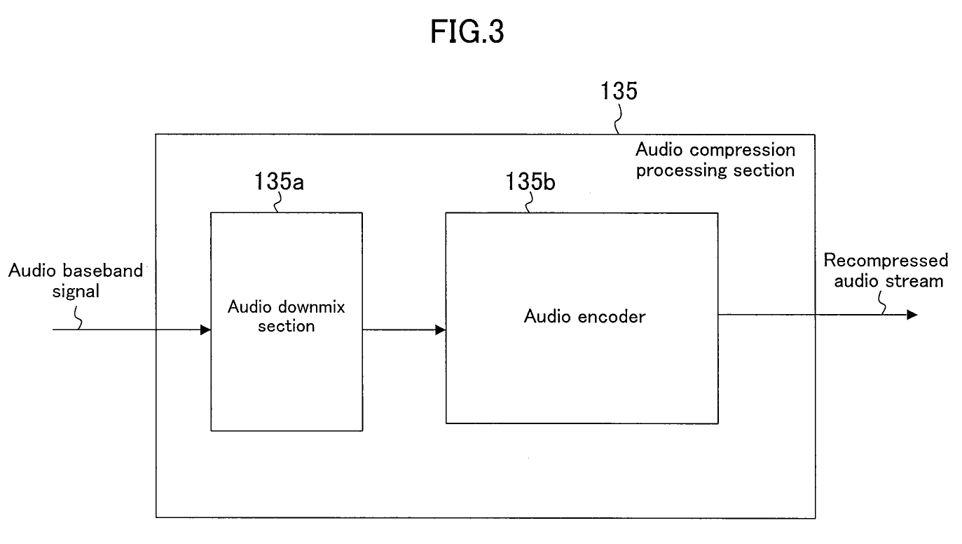

FIG. 3 is a block diagram illustrating an example of the configuration of the audio compression processing section 135. As shown in FIG. 3, the audio compression processing section 135 includes an audio downmix section 135a and an audio encoder 135b.

The audio downmix section 135a changes the number of output channels of the audio baseband signal to the number of output channels corresponding to the compression mode determined by the system control section 131.

For instance, the audio downmix section 135a downmixes a 5.1-channel audio baseband signal to a 2-channel audio baseband signal and outputs the 2-channel audio baseband signal.

In this case, if the 5.1-channel audio is defined as L (left channel), R (right channel), C (center channel), Sl (surround left channel), Sr (surround right channel), and LFT (low-frequency effects), the 5.1-channel audio baseband signal can be downmixed to the 2-channel audio baseband signal (mixL and mixR) to output the 2-channel audio baseband signal, by the following sum-of-product operations:

mixL=A0×L+A1×C+A2×Sl+A3×Sr

mixR=A0×R+A1×C+A4×Sl+A5×Sr

where A0 to A5 are coefficients.

The audio encoder 135b outputs an audio stream obtained by compressing with a given compression algorithm the audio baseband signal output from the audio downmix section 135a.

The compression algorithm in the audio encoder 135b is not particularly limited. For example, G.726, which is used in audio streams for mobile phones, MPEG4-AAC, which is typically used in BS digital broadcasting and in digital terrestrial broadcasting, AC3, which is used in DVD systems, or the like may be adopted.

The multiplexing processing section 140 multiplexes an input video stream and an input audio stream and outputs the resultant stream.

The content output device 150 outputs the stream multiplexed by the multiplexing processing section 140 (hereinafter referred to as the “multiplexed stream”) to the display device 200 and to the external media control section 160. In outputting the multiplexed stream to the external media control section 160, the content output device 150 uses an interface, such as Serial ATA, for example. In outputting the multiplexed stream to the display device 200, the content output device 150 uses a wired or wireless LAN (Local Area Network), for example. Examples of the network include Bluetooth, Ethernet (registered trademark), and the like.

The external media control section 160 receives the output of the tuner 110 and the output of the content output device 150, records the received content on the hard disk 170, the optical disk 180, or the semiconductor memory 190, and also reads content recorded on the hard disk 170, the optical disk 180, or the semiconductor memory 190. In a case where the content output from the tuner 110 is directly recorded on the hard disk 170 or the like, program information about the content is also recorded.

The configuration described above allows the audio/video recorder 100 to perform the above-mentioned first to third functions.

(Operation of the Audio/Video Recorder 100)

An operation of the audio/video recorder 100, in which a digital broadcast received by the tuner 110 is recompressed and then recorded on the hard disk 170 or the like, will be described by way of example.

First, upon receipt of the digital broadcast, the tuner 110 separates a video stream and an audio stream contained in the content from each other and outputs the video stream and the audio stream to the program information extraction section 120. The tuner 110 also outputs a received EPG (or data in a data broadcast) to the program information extraction section 120. Then the program information extraction section 120 outputs information on the genre of the program, contained in the EPG (or in the data in the data broadcast), to the audio/video stream compressor 130.

In the audio/video stream compressor 130, when the information on the genre is input, the system control section 131 determines a compression mode for the video stream and a compression mode for the audio stream in accordance with the information. Specifically, the system control section 131 determines whether or not recompression is necessary, and a resolution and the number of output channels in the case of the recompression. For example, if the content is a concert, the system control section 131 performs control so that the audio stream is output as it is to the multiplexing processing section 140, and the video stream is output to the video reproduction processing section 132. Furthermore, the system control section 131 determines a compression mode (an image resolution in this example) in the video resolution changer 134a so that the resolution becomes lower than that of the input video stream.

As a result, the video resolution changer 134a outputs to the image encoder 134b the video stream whose resolution has been changed to a lower image resolution as compared with the input video stream. The image encoder 134b compresses the received video stream with a given compression algorithm and outputs the resultant video stream to the multiplexing processing section 140.

The multiplexing processing section 140 multiplexes the input video stream and the input audio stream and outputs the multiplexed stream to the content output device 150. In this example, the multiplexing processing section 140 multiplexes the audio stream itself contained in the received content and the video stream recompressed by the audio/video stream compressor 130.

And the content output device 150 outputs the multiplexed stream to the external media control section 160 through a predetermined interface. Then the external media control section 160 records the received content on the hard disk 170, for example.

In the recorded content (a concert in this example), the size of the video stream has been reduced by the recompression as compared with the state in which the video stream was received, and the reduced size may cause the image quality to decline. However, the audio stream has been recorded in the same state in which the audio stream was received, which means that there is no deterioration in the audio quality.

In a case in which the content is a nature program showing nature scenes, for example, the audio/video recorder 100 determines that the content places importance on video. Therefore, the audio stream is downmixed and recorded, while the video stream is recorded in the same state in which the video stream was received. As a result, in this case, the audio quality declines as compared with the received audio stream, but the image quality does not deteriorate.

In the audio/video recorder 100, when content recorded on one of the hard disk 170, the optical disk 180, and the semiconductor memory 190 is recorded on another, the kind of the content is analyzed based on program information recorded together with the original content. And according to the kind (genre) of the content, a compression mode for the video stream and a compression mode for the audio stream are each determined.

As described above, in this embodiment, the respective compression modes for the video stream and the audio stream are determined separately according to the kind (genre) of the content.

### First Modified Example of the First Embodiment of the Invention

The compression algorithms in the video compression processing section 134 and in the audio compression processing section 135 may be determined in accordance with the kind of content input to the audio/video stream compressor 130.

In this modified example, the image encoder 134b and the audio encoder 135b are configured so as to be capable of performing compression with multiple different compression algorithms. The video resolution changer 134a and the audio downmix section 135a may be provided, but these members are not essential.

Also, the system control section 131 is configured so as to determine, according to the kind of content, whether the content places importance on video quality or audio quality, and then determine, in accordance with the determination result, whether or not recompression of the video stream and recompression of the audio stream are necessary, and compression algorithms in the case of the recompression.

That is, the respective compression modes for the video stream and the audio stream are also individually determined in this modified example.

### Second Modified Example of the First Embodiment of the Invention

The system control section 131 may determine, according to the compression mode of input content, whether or not recompression of the video stream and recompression of the audio stream are necessary, and a compression mode in the case of the recompression. In this case, information on the compression mode of the content is extracted by the program information extraction section 120, for example, and the extracted information is output to the system control section 131.

For instance, when the compression mode for an audio stream is Linear PCM, which is an uncompressed format, or Dolby Lossless, which is a reversible compression algorithm adopted by BD recorders, it is determined that the content places importance on audio quality rather than on video quality. Therefore, in this modified example, when the compression mode for an audio stream is an uncompressed mode or a reversible compression mode, the system control section 131 makes the determination that the audio stream should be output as it is regardless of the kind (genre) of the content.

That is, the respective compression modes for the video stream and the audio stream are also individually determined in this modified example.

As described above, in the first embodiment and the modified examples thereof, the compression mode for the video stream and the compression mode for the audio stream are separately determined in accordance with attributes of the content (which include both the kind of the content and the compression mode of the content). It is thus possible to compress the video stream and the audio stream (i.e., compress the content) with necessary image quality and audio quality maintained.

### Second Embodiment of the Invention

The audio/video recorder 100 may determine, according to the characteristics of an output destination, whether or not recompression of a video stream and recompression of an audio stream are necessary, and a compression mode in the case of the recompression.

Specifically, the “characteristics of the output destination” herein means the image display resolution of the display device 200, the number of channels for outputting audio, and the transmission capacity of a transmission path for transmitting video and audio streams from the content output device 150 to the display device 200 or the like. In this embodiment, it is assumed that the system control section 131 beforehand has information on the image display resolution of the display device 200, the number of audio output channels, and the transmission capacity of the transmission path.

The system control section 131 determines whether or not recompression of a video stream and recompression of an audio stream are necessary, and a resolution and the number of output channels in the case of the recompression, in accordance with the image display resolution of the output destination, the number of output channels, and the transmission capacity.

In the case of recompression, the system control section 131 determines a resolution in the video resolution changer 134a so that the output fits the image display resolution of the display device 200, and makes the video resolution changer 134a perform the image resolution change. The system control section 131 also makes the audio downmix section 135a perform downmixing so that the output is suited for the output channels of the output destination.

Thus, in this embodiment, it is possible to compress the video stream and the audio stream with image quality and audio quality suitable for the output destination, such as the display device, maintained.

In the foregoing embodiments and the modified examples thereof, the information on the genre of the content does not necessarily have to be obtained from the broadcasting. The information on the genre may be obtained from the Internet, for example.

Also, the broadcast to be received may be an analog broadcast (i.e., a video stream and an audio stream input to the audio/video stream compressor are uncompressed).

In the second embodiment, as described in the first modified example of the first embodiment, the compression algorithms themselves in the video compression processing section 134 and in the audio compression processing section 135 may be changed to perform recompression.

Moreover, in the foregoing embodiments and the modified examples thereof, either the video stream or the audio stream on which importance is placed is output in the compression mode in which that stream was input. However, a stream on which importance is placed may also be recompressed so long as the resulting degradation is acceptable

As described above, the audio/video stream compressor and the audio/video recorder according to the invention have the effect that a video stream and an audio stream can be compressed with necessary image quality and audio quality maintained. The inventive audio/video stream compressor and the inventive audio/video recorder are thus applicable to, e.g., audio/video stream compressors which compress video streams and audio streams and audio/video recorders which compress video streams and audio streams and record the compressed streams on recording media.

What is claimed is:

1. An audio/video stream compressor for compressing a video stream and an audio stream contained in content, the compressor comprising:
a video compression processing section capable of compressing the video stream in multiple different compression modes;
an audio compression processing section capable of compressing the audio stream in multiple different compression modes; and
a system control section for determining a compression mode in the video compression processing section and a compression mode in the audio compression processing section,
wherein the video compression processing section and the audio compression processing section compress the video stream and the audio stream, respectively, in the respective compression modes determined by the system control section.

2. The compressor of claim 1, wherein the system control section determines the compression mode in the video compression processing section and the compression mode in the audio compression processing section in accordance with an attribute of the content.

3. The compressor of claim 1, wherein the video stream and the audio stream have been compressed before these streams are input; and
the system control section performs control according to an attribute of the content so that one of the video stream and the audio stream is compressed and then output, and the other is output without further compression.

4. The compressor of claim 1, wherein the system control section determines the compression mode in the video compression processing section and the compression mode in the audio compression processing section in accordance with a resolution of a display device for displaying the video stream, the number of audio channels of a device for outputting the audio stream, and the transmission capacity of a transmission path for transmitting the video stream and the audio stream.

5. The compressor of claim 2, wherein the system control section determines the compression mode in the video compression processing section and the compression mode in the audio compression processing section in accordance with a compression mode for the video stream and a compression mode for the audio stream.

6. The compressor of claim 2, wherein the system control section determines the compression mode in the video compression processing section and the compression mode in the audio compression processing section in accordance with the kind of the content.

7. The compressor of claim 5, wherein the audio stream has been compressed before the audio stream is input; and
when the compression mode for the input audio stream is an uncompressed mode or a reversible compression mode, the system control section performs control so that the input audio stream is output without further compression.

8. The compressor of claim 2, further comprising:
a program information extraction section for extracting the attribute of the content,
wherein the system control section obtains the attribute of the content from the program information extraction section.

9. An audio/video recorder comprising:
the audio/video stream compressor of claim 8; and
a tuner for receiving, together with the content containing the video stream and the audio stream, program information containing information indicating the attribute of the content,
wherein the program information extraction section extracts the attribute of the content in accordance with the program information.
